(19) United States
(12) Patent Application Publication
(10) Pub. No.: US 2003/0128229 A1
(43) Pub. Date: Jul. 10, 2003

(54) Allowing a user to determine whether to view web content based on cost

(75) Inventors: James C. Colson, Austin, TX (US); Ajei Gopal, Bronx, NY (US)

Correspondence Address: BRACEWELL & PATTERSON, L.L.P., P.O. BOX 969, AUSTIN, TX, 78767-0969, US

(73) Assignee: International Business Machines Corporation

(21) Appl. No.: 10/042,047

(22) Filed: Jan. 8, 2002

(51) Int. Cl. G09G 5/00

(52) U.S. Cl. 345/733

(57) ABSTRACT

A method, system and computer program for delivering content from an Internet content server to a user device that has a limited sized display, such as found on a Personal Digital Assistant (PDA). A billing server, which may be the Internet web page content server or an intermediary web server, sends a cost option to the user device. The user of the device has an option of receiving, if at all, the content from the web page for a cost. The cost may be dependent on how many, if any, advertising displays the user is willing to receive as part of the web page content. The cost may be dependent on options offered the user, such as how old the content is in the case of time sensitive information such as stock quotes. In a preferred embodiment, the cost option is included in the web page header as a script using a format such as extensible Markup Language (XML) or its equivalent for the user device, such as Wireless Markus Language (WML).

### BACKGROUND OF THE INVENTION

1. Technical Field

The present invention relates in general to the field of computer networks, and, in particular, to the display of Internet web page content. Still more particularly, the present invention relates to an improved method and system for allowing a user of a device having a limited size display to pay for receipt of the web page content.

2. Description of the Related Art

The Internet is a worldwide decentralized network of computers having the ability to communicate with each other. The Internet has gained broad recognition as a viable medium for communicating and interacting across multiple networks. The World Wide Web (WWW) is comprised of server-hosting computers (web servers) in which HyperText documents (referred to as web pages) are typically stored. Web pages are accessible by client programs (e.g., web browsers) with the HyperText Transfer Protocol (HTTP) via a Transmission Control Protocol/Internet Protocol (TCP/IP) connection between the user's user device and a content web server. The web browser sends an HTTP request for a web page to a web content server, which responds by sending the web page content, typically in HyperText Markup Language (HTML) which is renderable by desktop computers, to the user device. Much of the web page content sent is free to the user. This is possible because the provider of the web page content is typically financially supported by advertisements that are delivered along with the desired web page content. These advertisements are typically in the form of displays on the web page. The display may be a static advertisement for a product, or may incorporate animation, sound and/or links to the advertiser's web page. Such advertisement displays often require a high bandwidth for transmitting their content, and they occupy a large portion of the viewable area of the web page.

With the increasing mobility of today's society, the demand for mobile computing capabilities has also increased. Many workers and professionals are downsizing their laptop computers to smaller palmtop or handheld devices, such as Personal Digital Assistants (PDA's). In addition, many people are utilizing cellular telephones to access the Internet. Computing devices including, but not limited to, PDA's, cellular telephones, and like computing devices are often collectively referred to as “pervasive” computing devices. Typically, pervasive computing devices have displays that are small in size compared to desktop computer displays. A desktop computer display having an array of 1,024 pixels by 768 pixels may be able to display a large (e.g., 2-megabit) 24-bit per pixel color image. A pervasive computing device with a smaller display having an array of only 120 pixels by 120 pixels, and with the ability to display only about 3-bits per pixel, may have to ignore much of the image data. As a result, the image may not be displayed properly, if at all, via the pervasive computing device display unless the displayed content is modified. Text font and size within the web page may also need to be changed to permit the readable display on a pervasive computing device display. As a result, content portions of a web page, such as images and text that are otherwise displayable on a desktop computer display, typically are not displayable on a pervasive computing device display unless some modifications to the images and/or text (i.e., the content) are made through software translation known as transcoding. The transcoding process may change the original content into a style, format and/or language required by the pervasive user device. For example, HTML content may need to be transcoded into a language understood by the pervasive device, such as Compressed Markup Language (CML), Wireless Markup Language (WML), Handheld Device Markup Language (HDML) and others. In addition, performance limitations of pervasive computing devices, such as memory, size and connection bandwidth, may also require the elimination of portions of the web page content for proper display. Further, the content itself may need to be modified by paring down the amount of text and other information, so that the essential information may be displayed on the pervasive device.

Because of their relatively small size, space on a pervasive device's display is limited and at a premium. If advertisement displays are included in the smaller display, less room is left for the desired web page content, and limited transmission bandwidth capacity is taken up, thus slowing down the display. In addition, content may have differing values to the user depending on the content itself, including the age of the content for time sensitive material, as well as the amount or format of the content.

Therefore there exists a need for a method that delivers web page content on a pervasive device's display on a pay-per-view basis, including the option of receiving no or fewer advertisement displays. Further, it would be desirable to devise a system having the means to implement the web page content delivery method. In addition, it would also be desirable to devise a computer program product wherein such a web page content delivery method may be performed on a computer system.

### SUMMARY OF THE INVENTION

The present invention relates to a method, system and computer program for delivering content from an Internet content server to a user device that has a limited sized display, such as found on a Personal Digital Assistant (PDA). A billing server, which may be the Internet web page content server or an intermediary web server, sends a cost option to the user device. The user of the device has an option of receiving, if at all, the content from the web page for a cost. The cost may be dependent on how many, if any, advertising displays the user is willing to receive as part of the web page content. The cost may be dependent on options offered the user, such as how old the content is in the case of time sensitive information such as stock quotes. In a preferred embodiment, the cost option is included in the web page header as a script using a format such as eXtensible Markup Language (XML) or its equivalent for the user device, such as Wireless Markus Language (WML). The above, as well as additional objectives, features, and advantages of the present invention will become apparent in the following detailed written description.

The above, as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as the preferred mode of use, further objects and advantages thereof, will best be understood by reference to the following detailed description of an illustrative embodiment when read in conjunction with the accompanying drawings, wherein:

FIG. 1 is a block diagram of connections between a user device and an Internet content server;

FIG. 2 is a block diagram of connections between a user device and an Internet content server with an intermediary web server located between the user device and the Internet content server;

FIG. 3 is a high-level flow chart illustrating steps in providing web page content with a reduced number of advertisement displays; and

FIG. 4 depicts a Personal Digital Assistant displaying cost options for web page content that has had advertisement displays removed.

### DETAILED DESCRIPTION OF THE PREFERRED EMBODIMENT

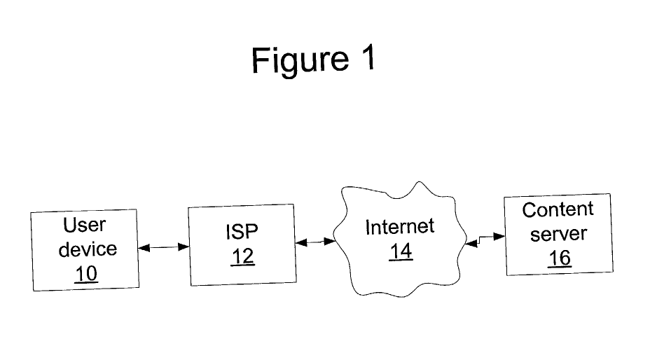

With reference now to the drawings and in particular to FIG. 1, there is depicted a simplified block diagram of an Internet connection between a user device 10 and a content server 16. Content server 16 serves content from any content provider, typically a web page located at a specified Uniform Resource Locator (URL) address. User device 10 connects to an Internet 14 typically via an Internet Service Provider (ISP) 12. Internet 14 is connected to content server 16, completing the connection between user device 10 and content server 16.

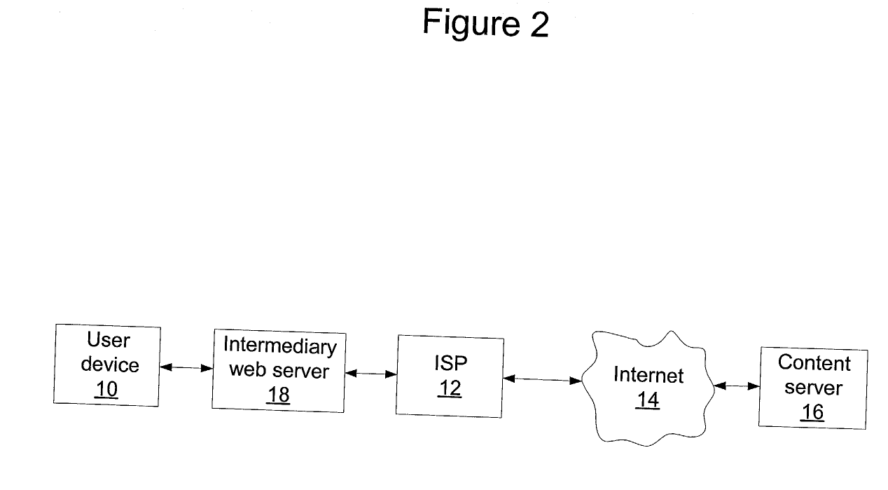

Alternatively, as depicted in FIG. 2, an intermediary web server 18 may be connected between user device 10 and content server 16. Intermediary web server 18 may be connected anywhere between user device 10 and content server 16, although typically intermediary web server 18 is connected between user device 10 and ISP 12 as shown.

In networks with or without intermediary web server 18, if user device 10 is a desktop or laptop computer, a request for a web page is typically sent from user device 10 as a HyperText Transfer Protocol (HTTP) request, and the web page returned in standard HyperText Markup Language (HTML) protocol. If user device 10 is a user device having a limited sized display, such as a Personal Digital Assistant (PDA), the web page must be returned in an understandable language, such as Handheld Device Markup Language (HDML) or an eXtensible Markup Language (XML) such as Wireless Markup Language (WML). Typically, the HTML content is transcoded in intermediary web server 18. Alternatively, the web page content is sent from content server 16 in the understandable language for the PDA or similar device, with content server 16 being a dedicated server using the needed language.

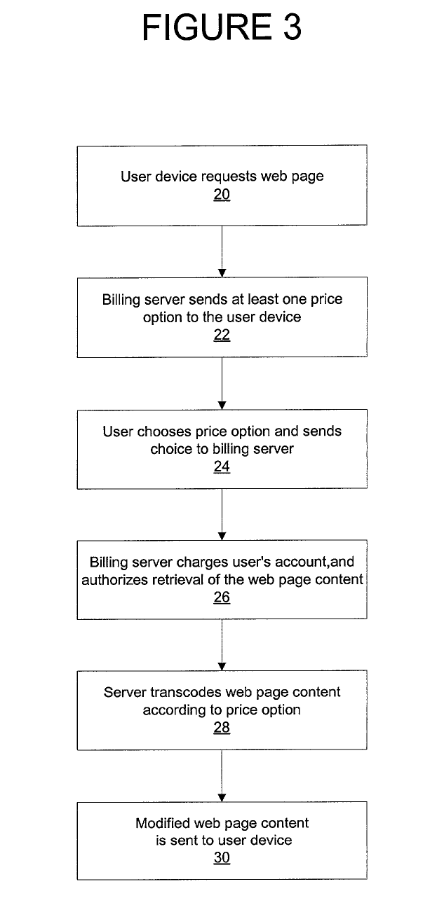

Referring now to FIG. 3, the user of user device 10 requests a web page, as depicted in block 20. A billing server, which may be content server 16 or intermediary web server 18, transmits at least one cost option to user device 10, as illustrated in block 22. The cost option in a preferred embodiment is transmitted as a cost attribute of the content through an XML script in the header of the web page content. For example, this COST attribute could be of the form:

<document>

...
<SOMEITEM NAME=“ITEM NAME” COST = “200>

...content goes here...

<SOMEITEM>

<document>

where ITEMNAME defines the content being offered in a modified form from the web page, and “200” represents some canonical unit of cost to provide the content defined by ITEMNAME. The COST attribute may then be used in conjunction with the billing server on behalf of the request by user device 10 to indicate to a billing system how much to bill the user of user device 10. The user would preferably have an account set up by the billing server, with appropriate security protection through the connection between user device 10 and the billing server.

The cost option in a preferred embodiment of the invention is based on the removal of at least one advertising display found within the web page content. For example, if the web page has four advertising display banners, and the user were willing to view only two of the four banners, a cost option, typically in the form of a link button on the display, may offer to display the web page with only two banners for a small charge. If the user was willing only to read one banner, the cost would increase, and if the user was willing to read no banners, the cost would increase further. Thus, the user has control over how much of his limited sized display will be occupied by the advertisements.

Alternatively, the user may be given the option of paying to view only a portion of the Internet content. For example, the use may wish to view only an image from a web page, and may select an option as described herein to agree to pay for only that image. That is, if the user desires to see only a portion of the web page, cost options may be offered analogous to those described for viewing time sensitive information as described above.

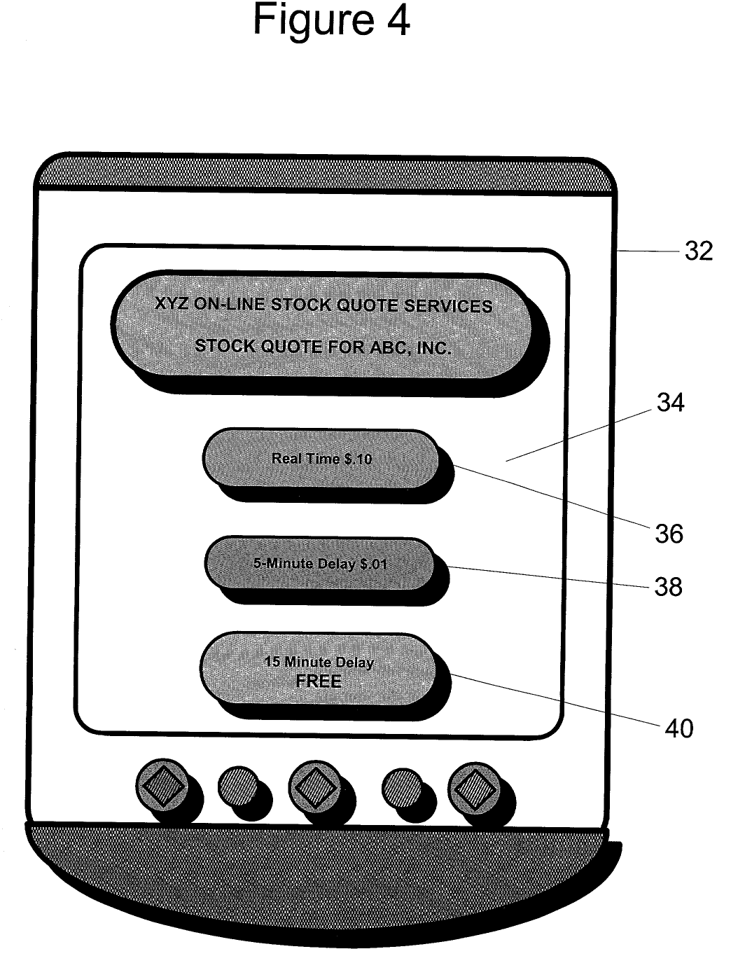

Alternatively, the user may be given the option of paying more or less for content that is time sensitive, such as a stock quote. For example, as illustrated in FIG. 4, a PDA 32 with a limited sized display 34, which in a preferred embodiment has less than forty square inches of viewable area, may display a plurality of interactive buttons offering to display a stock quote having different ages. If the stock quote is in real time, button 36 can be touched with a PDA stylus to activate a command to the billing server to retrieve a real-time quote for the stock requested at the shown cost of 10 cents. If the user can use a stock quote that is five minutes old, he touches button 38 and agrees to pay a penny. If the stock quote required is more than fifteen minutes old, he touches button 40 for a free quote. In an alternative embodiment, buttons 36, 38, and 40 and like buttons may be replaced by a slider bar (not shown), which allows the user to slide a curser along the bar to vary the cost of viewing content depending on age, amount or other quantifiers or qualifiers of the content.

Referring again to FIG. 3, the user chooses a cost option for the content to be displayed, and sends his choice by activating a touch button or like device described above and illustrated in block 24. This choice is transmitted to the billing server, which then charges the user's account, and authorizes the retrieval of the web page content, as shown in block 26. The format and content of the web page content are then transcoded according to the cost option selected, as illustrated in block 28. This transcoding preferably occurs in intermediary web server 18, unless content server 16 has this ability. The transcoding process includes not only modifying the content, such as removing advertising displays, but also transcodes the language format, such as converting the content from HTML format into WML understandable by the user device 10 having a limited sized display, such as a PDA. Other languages into which the content may be transcoded include, but are not limited to, Voice XML, NewsML and similar languages. The modified web page content is then sent to user device 10, as shown in block 30.

As described above, it is significant that the user must make a conscious decision to view any part or all of a web page content. The user has control over how much he will pay, if anything, to view and/or receive any of the content, with different cost options depending on content inclusion (what percentage of the web page is viewed), exclusion (removal of advertising displays) and content itself (timeliness, etc.) The present invention further allows for a business model that makes it cost effective for content to be provided to a user device 10 having a limited sized display.

While cost options have been described related to costs defined by currency, it should be understood and appreciated that cost may also be defined in a preferred embodiment as any form of remuneration, including bartering. For example, the user may barter on-line with goods or services for the right to view content as described above.

While the invention has been particularly shown and described with reference to a preferred embodiment, it will be understood by those skilled in the art that various changes in form and detail may be made therein without departing from the spirit and scope of the invention.

What is claimed is:

1. A method for receiving on a user device a web page content from a network content server, said method comprising:
requesting, from a user device and via a billing server, a web page content from a network content server;
displaying on the user device at least one offer from the billing server to view at least a portion of the web page content for a cost;
selecting at the user device at least one of the at least one offers;
receiving at the user device the at least a portion of the web page content; and
displaying on the user device the at least a portion of the web page content.

2. The method of claim 1, wherein the at least one offer is based on a removal of advertisement from the web page content.

3. The method of claim 1, wherein the at least one offer is based on an age of the at least a portion of the web page content.

4. The method of claim 1, wherein the at least a portion of the web page content is displayed on a computer device having a limited sized display of less than forty square inches of viewable area.

5. The method of claim 1, wherein the network content server is on an Internet.

6. The method of claim 1, wherein the billing server and the network content server are a same device.

7. A system for receiving on a user device a web page content from a network content server, said system comprising:
means for requesting, from a user device and via a billing server, a web page content from a network content server;
means for displaying on the user device at least one offer from the billing server to view at least a portion of the web page content for a cost;
means for selecting at the user device at least one of the at least one offers;
means for receiving at the user device the at least a portion of the web page content; and
means for displaying on the user device the at least a portion of the web page content.

8. The system of claim 7, wherein the at least one offer is based on a removal of advertisement from the web page content.

9. The system of claim 7, wherein the at least one offer is based on an age of the at least a portion of the web page content.

10. The system of claim 7, wherein the at least a portion of the web page content is displayed on a computer device having a limited sized display of less than forty square inches of viewable area.

11. The system of claim 7, wherein the network content server is on an Internet.

12. The system of claim 7, wherein the billing server and the network content server are a same device.

13. A computer program product for receiving on a user device a web page content from a network content server, said computer program product comprising:
computer program code for requesting, from a user device and via a billing server, a web page content from a network content server;
computer program code for displaying on the user device at least one offer from the billing server to view at least a portion of the web page content for a cost;
computer program code for selecting at the user device at least one of the at least one offers;
computer program code for receiving at the user device the at least a portion of the web page content; and
computer program code for displaying on the user device the at least a portion of the web page content.

14. The computer program product of claim 13, wherein the at least one offer is based on a removal of advertisement from the web page content.

15. The computer program product of claim 13, wherein the at least one offer is based on an age of the at least a portion of the web page content.

16. The computer program product of claim 13, wherein the at least a portion of the web page content is displayed on a computer device having a limited sized display of less than forty square inches of viewable area.

17. The computer program product of claim 13, wherein the network content server is on an Internet.

18. The computer program product of claim 13, wherein the billing server and the network content server are a same device.

19. A method for transmitting web page content from a network content server to a user device, said method comprising:
receiving at a billing server a request from a user device for a web page content from a network content server;
sending to the user device from the billing server a display of at least one offer to view at least a portion of the web page content for a cost;
receiving from the user device at least one selection of the at least one offers; and
sending the at least a portion of the web page content to the user device.

20. The method of claim 19, wherein the at least one offer is based on a removal of advertisement from the web page content.

21. The method of claim 19, wherein the at least one offer is based on an age of the at least a portion of the web page content.

22. The method of claim 19, wherein the at least one offer is defined by a script header to the web page content.

23. The method of claim 22, further comprising parsing the script header to generate at the user device a display of the at least one offer.

24. The method of claim 19, wherein the at least a portion of the web page content is formatted to be displayed on a computer device having a limited sized display of less than forty square inches of viewable area.

25. The method of claim 19, wherein the network content server is on an Internet.

26. The method of claim 19, wherein the billing server and the network content server are a same device.

27. A system for transmitting web page content from a network content server to a user device, said method comprising:
means for receiving at a billing server a request from a user device for a web page content from a network content server;
means for sending to the user device from the billing server a display of at least one offer to view at least a portion of the web page content for a cost;
means for receiving from the user device at least one selection of the at least one offers; and
means for sending the at least a portion of the web page content to the user device.

28. The system of claim 27, wherein the at least one offer is based on a removal of advertisement from the web page content

29. The system of claim 27, wherein the at least one offer is based on an age of the at least a portion of the web page content.

30. The system of claim 27, wherein the at least one offer is defined by a script header to the web page content.

31. The system of claim 30, further comprising means for parsing the script header to generate at the user device a display of the at least one offer.

32. The system of claim 27, wherein the at least a portion of the web page content is formatted to be displayed on a computer device having a limited sized display of less than forty square inches of viewable area.

33. The system of claim 27, wherein the network content server is on an Internet.

34. The system of claim 27, wherein the billing server and the network content server are a same device.

35. A computer program product for transmitting web page content from a network content server to a user device, said computer program product comprising:
computer program code for receiving at a billing server a request from a user device for a web page content from a network content server;
computer program code for sending to the user device from the billing server a display of at least one offer to view at least a portion of the web page content for a cost;
computer program code for receiving from the user device at least one selection of the at least one offers; and
computer program code for sending the at least a portion of the web page content to the user device.

36. The computer program product of claim 35, wherein the at least one offer is based on a removal of advertisement from the web page content.

37. The computer program product of claim 35, wherein the at least one offer is based on an age of the at least a portion of the web page content.

38. The computer program product of claim 35, wherein the at least one offer is defined by a script header to the web page content.

39. The computer program product of claim 38, further comprising computer program code for parsing the script header to generate at the user device a display of the at least one offer.

40. The computer program product of claim 35, wherein the at least a portion of the web page content is formatted to be displayed on a computer device having a limited sized display of less than forty square inches of viewable area.

41. The computer program product of claim 35, wherein the network content server is on an Internet.

42. The computer program product of claim 35, wherein the billing server and the network content server are a same device.
